(19) United States
(12) Patent Application Publication
(10) Pub. No.: US 2010/0045712 A1
(43) Pub. Date: Feb. 25, 2010

(54) Printing press with highlighting device for producing personalized printed products

(75) Inventor: John Sheridan Richards, Barrington, NH (US)

Correspondence Address: Davidson, Davidson & Kappel, LLC, 485 7th Avenue, 14th Floor, New York, NY, 10018, US

(73) Assignee: Goss International Americas, Inc., Dover, NH (US)

(21) Appl. No.: 12/229,363

(22) Filed: Aug. 22, 2008

(51) Int. Cl. H04N 1/034

(52) U.S. Cl. 347/3

(57) ABSTRACT

A printing press is provided. The printing press includes a printing unit printing images on a substrate, a highlight application unit producing highlights on the substrate and a controller directing the highlight application unit to produce the highlights on the substrate. A method for producing a highlighted printed product is also provided.

The present invention relates generally to printing presses and more specifically to a printing press with a highlight application unit.

### BACKGROUND OF INVENTION

U.S. Pat. No. 7,278,094 discloses variable text processing for an electronic press. The electronic press utilizes the output of a publishing step, during which the contents of one or more book versions are determined. All of the versions could include a set of common pages, with one or more of the versions including one or more additional pages unique to such version(s). Alternatively, all of the versions may be completely different, in the sense that there are no pages common to two or more of the versions.

U.S. Pat. Pub. No. 2002/0040374 discloses a method of producing a mass distributed publication through the creation of a plurality of subscriber specific versions, includes obtaining subscriber profile information relating to the nature of the subscriber's content preferences. A content database is provided that contains a plurality of content items. A computer is employed to select content items from the content databases, based upon the subscriber's content preferences. The selected items are forwarded to a high speed printer capable of printing at least one hundred pages per minute. The pages printed by the digital printer are then assembled into a unitary publication.

U.S. Pat. Pub. No. 2007/0240592 discloses an inkjet printing system for an offset printing press. An add-on unit in the form of an inkjet printing system is provided to make it possible for a printing press that operates by the offset printing principle to add additional information, including variable information and information that repeatedly changes during a printing run, to any desired place within the printed product. The unit includes an inkjet printhead mounted on a crosshead is positioned transversely to the direction of web transport in an operating position relative to a web of paper within the printing press in a printing unit or at least in the vicinity of a printing unit.

### BRIEF SUMMARY OF THE INVENTION

A printing press is provided. The printing press includes a printing unit printing images on a substrate, a highlight application unit producing highlights on the substrate and a controller directing the highlight application unit to produce the highlights on the substrate.

A method for producing a highlighted printed product is also provided. The method includes the steps of determining at least one of interests of a customer or information about a customer; using the at least one of interests of the customer or information about the customer to identify customer-specific text and images from common text and graphics to be printed on a substrate; printing the common text and graphics on the substrate; highlighting the customer-specific text and graphics with a highlight application unit as the customer-specific text and graphics pass by the highlight application unit.

### BRIEF DESCRIPTION OF THE DRAWINGS

The present invention is described below by reference to the following drawings, in which:

FIG. 1 shows a schematic side view of a printing press according to an embodiment of the present invention;

FIG. 2 shows two representative pages that have been highlighted differently on an individual basis according to an embodiment of the present invention; and

FIG. 3 shows a flow chart that schematically illustrates the relationships between components of the controller and the highlight application unit.

### DETAILED DESCRIPTION

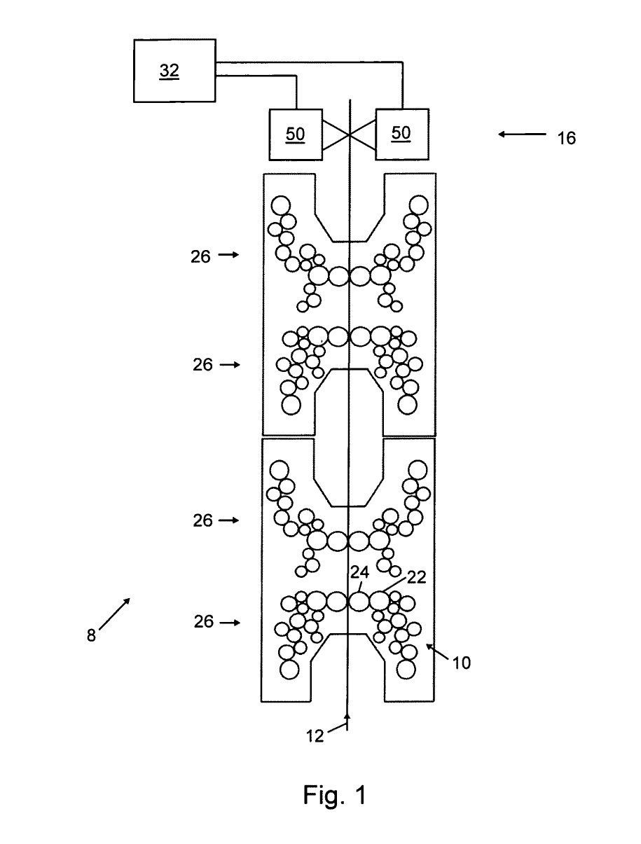

FIG. 1 shows a schematic side view of a printing press 18 according to an embodiment of the present invention. Printing press 18 includes a four-color web-fed offset lithographic fixed image printing tower 14 including four printing units 26, 126, 226, 326. Each printing unit 26, 126, 226, 326 includes two sets of plate cylinders 22 and blanket cylinders 24 and prints on both sides of web 12. Plate cylinders 22 may each include a printing plate and blanket cylinders 24 may each include a printing blanket. In each printing unit 26, 126, 226, 326, ink is fed by inkers 10 to plate cylinders 22, which print inked images on blanket cylinders 24. Blanket cylinders 24 then print the inked images on web 12. Each printing unit 26, 126, 226, 326 prints images in a different colored ink to so that printing press 18 prints four color images on web 12. In alternative embodiments, lithographic printing tower 14 may be replaced by another printing device utilizing a different image carrier. Printing devices for gravure printing, letterpress printing, screen printing, for example, may be substituted for printing tower 14.

As web 12 passes through printing tower 14, printing units 26 print images on web 12. For each group of printed products, printing tower 14 prints common text and graphics, which are the same for the entire group of printed products, on web 12. Illustrative of a group of printed products is a group of daily newspapers, each with the same text and graphic content.

After common text and graphics are printed on web 12, web 12 passes through a highlight application unit 16, which prints over the common text and graphics in a manner that highlights certain text and graphics as dictated by a controller 32. A highlight application unit 16 includes highlight applicators 50 which disperse highlight ink on web 12 at locations determined by controller 32. In the embodiment shown in FIG. 1, highlight applicators 50 of highlight application unit 16 print on both sides of web 12. In an alternative embodiment, highlight application unit 16 only prints on one side of web 12. The arrangement of highlight application unit 16 and the number of highlight applicators 50 can vary according to whether both sides of web 12 need to be highlighted.

The ink used in highlight application unit 16 may vary in color and ink may be transparent or semi-transparent. Regardless of the color of the ink or the transparency of the ink, ink is dispersed in an arrangement and thickness that allows a customer to see through the ink to the underlying text or graphics, but still draws the attention of the customer to the highlighted text or graphics underlying the highlighting.

In one embodiment highlight application unit 16 may be an inkjet printing unit or units. Inkjet printing units transfer ink directly onto the web in the form of small ink droplets, where ink solidifies after drying. The inkjet printing unit may be a large-dot, low-resolution, high-speed inkjet.

After passing through highlight application unit 16, web 12 may then undergo a number of finishing operations performed by post-press equipment to form a final printed product. These finishing operations may include folding, trimming, collating, perforating, stitching, inserting, or any other finishing operation performed in a lithographic printing press.

Highlight application unit 16 highlights predetermined areas, as dictated by controller 32, based on particular interests of the customer receiving the final individual printed product or information or characteristics of the customer receiving the final individual printed product. While each group of printed products contains the same text and graphic content, each individual printed product may be highlighted differently. For example, while a group of newspapers for a particular date have the same arrangement of text and graphics, each individual newspaper will have certain customer-specific text and graphics highlighted according to the interests or characteristics of the customer. In one advantageous embodiment, desired advertisements can be highlighted based on customized advertising information. Printing press 8 is configured so that printing tower 14 can print the same text and graphics on web 12 to produce a group of final printed products with the same text and graphics, yet the presence of highlight application unit 16 allows each final printed product to be personalized for each customer with customer-specific text and graphics highlighted. This configuration avoids the expense and time of having to print a separate personalized printed product for each customer while at the same time the configuration identifies, by highlighting, sections of the printed product that match the interests of each customer. As a result, a customer may more easily and rapidly browse through the printed product and identify the areas that interest the customer.

Depending on the interests of the different customers receiving an individual printed product from a group of printed products, each individual printed product of the group can have different text and graphics highlighted, only a few individual printed products of the group can have the same text and graphics highlighted, or many individual printed products of the group can have the same text and graphics highlighted. Additionally, highlights may be shaped differently and be of different colors. One shape or color may have a particular meaning to a customer, while another shape or color may have a different meaning to the same customer.

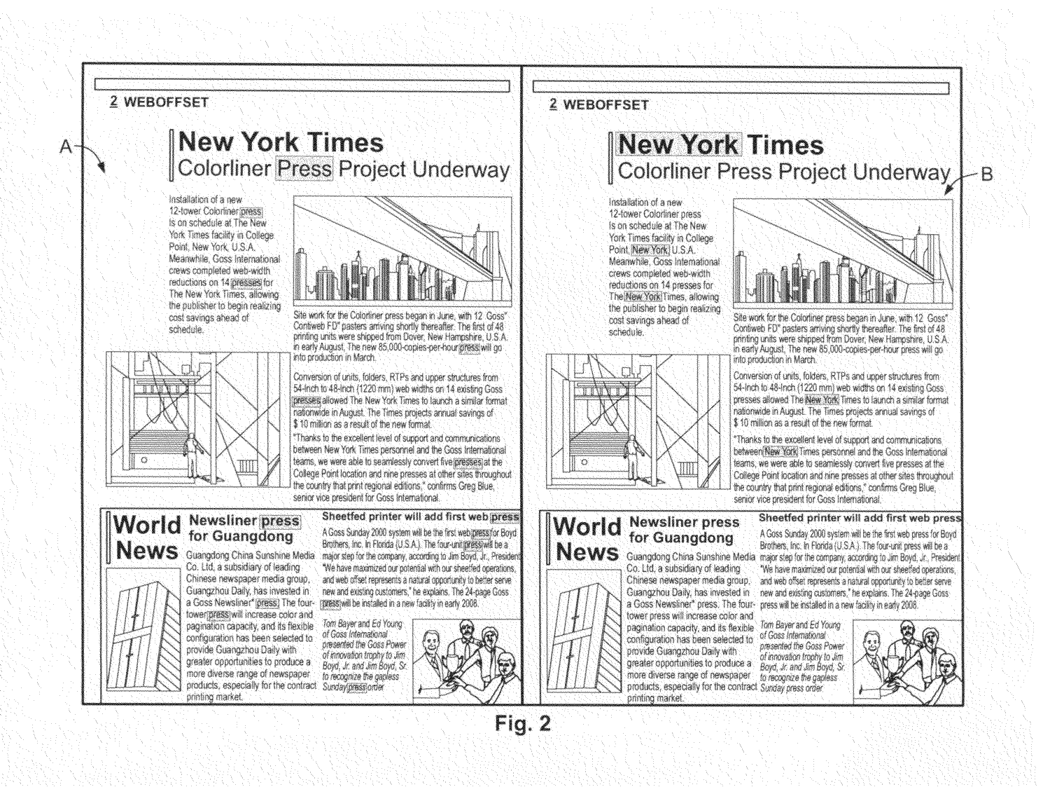

FIG. 2 shows two representative pages that have been highlighted differently on an individual basis according to an embodiment of the present invention. A first individual publication A and a second individual publication B are individual printed products of a group of printed products, which in this example is Issue 61 of Web Offset Magazine. Each individual publication of Issue 61 of Web Offset Magazine includes the same text and graphics; however, as demonstrated by individual publication A and individual publication B, individual publications of Issue 61 of Web Offset Magazine may be highlighted differently. A first customer receiving publication A has different identified interests or characteristics than a second customer receiving publication B, therefore publication A and publication B are highlighted differently. Thus, publication A has different customer specific text and graphics than publication B.

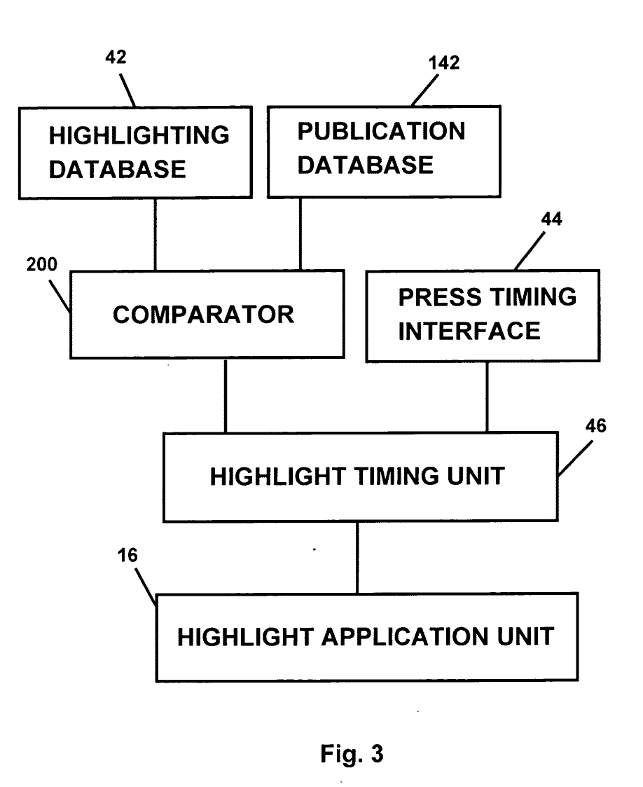

FIG. 3 shows a flow chart that schematically illustrates the relationships between components of controller 32 and highlight application unit 16 according to an embodiment of the present invention. Controller 32 may include a highlighting database 42, a publication database 142, a comparator 200, a press timing interface 44, and a highlight timing unit 46. Controller 32 directs highlight application unit 16 to highlight customer specific text and graphics that interest each customer receiving a printed product of a printed product group.

Highlighting database 42 may include the interests of each individual customer and how different interests of a particular individual customer are highlighted. For example, if a customer has interests of football and Broadway shows, highlighting database 42 can indicate these interests for the particular individual customer and can indicate that text and graphics, including advertisements, related to football should be highlighted in a first color or shape and the text and graphics related to Broadway shows, including advertisements, should be highlighted in a second color or shape. Customer interests, information and highlighting preferences can be entered manually by customers, via a communication mode such as the internet, or may be entered by a company printing the printed product. Highlighting database 42 may also include customer information, for example demographic information such as age and income level or geographic information of each customer, that may help determine interests of a customer or whether the customer would be a proper target of certain advertisements.

Publication database 142 may include all text and graphics to be printed in publications as well as the location and arrangement of articles and advertisements in the publication, including the arrangement of the articles and advertisements when printed on a web. Publication database may include the contents of more than one publication. Publication database 142 is designed to store and organize all text and graphics to be printed in a publication and the location and arrangement of all text and graphics to be printed in a publication. The publication database 142 may also include information concerning which advertisements will be printed in a publication and which customer groups, for example demographically and/or geographically, are targets for an advertisement. For example, the publication database may identify targeted customer groups, such as persons living on the west coast that make more than $60,000 a year. In one embodiment a targeted advertising database may be included separately of the highlighting database 42 and may include characteristics of targeted customers for each advertisement.

Comparator 200 may compare interests of and information about individual customers stored in the highlighting database, and any instruction of how certain categories of customer-specific text and graphics are highlighted, with common text and graphics in a publication and the location and arrangement of the common text and graphics of a publication stored in publication database 142. Comparator 200 may also compare targeting advertising information with customer information and interests. Comparator 200 may then identify customer-specific text and graphics, including advertisements, to be printed in a publication and where customer-specific text and graphics are located in the publication to determine which areas of the publication should be highlighted.

Press timing interface 44 can calculate or receive input of a velocity of web 12 and the location and arrangement of text and graphics printed on web 12 (FIG. 1). Press timing interface may also indicate when text and graphics are printed or determined to be printed on web 12 (FIG. 1). Press timing interface 44 may determine where printed text and graphics are located in press 18 (FIG. 1) in relation to highlight application unit 16 (FIG. 1) and when printed text and graphics will pass by highlight application unit 16.

Comparator 200 and press timing interface 44 may each send signals to highlighting timing unit 46 transmitting information indicating the location and arrangement of customer-specific text and graphics in a publication and when portions of a publication, including customer-specific text and graphics, will be passing by highlight application unit 16, respectively. Highlight timing unit 46 may determine, based on which text and graphics need to be highlighted and when those customer- specific text and graphics, as printed on the web 12 (FIG. 1), passes by highlight application unit 16 and at what time highlight application unit 16 disperses highlighting ink on web 12 (FIG. 1). Highlight timing unit 46 may then send a signal to highlight application unit 16 directing highlight application unit 16 to disperse ink on web 12 (FIG. 1). The signal may also indicate the color of the ink and the shape of the highlight that highlight application unit 16 may apply.

The present invention will be useful for a number of printed publications, including, but not limited to, newspapers, magazines, journals, catalogues, and newsletters. The arrangement of the elements of the printing press may be different depending on the type of printed product. The highlight application unit may also be located at different positions within the printing press. For example, it may be located immediately after the printing units, as shown in FIG. 1, or it can be located with the post-press equipment in the areas where finishing operations are performed. When the highlight application unit is with post press equipment following a collator it may be possible that only the front and back pages of the collated printed product may be highlighted. The highlight application unit may even be integrated into a piece of post-press equipment, such as a newspaper collator described in U.S. Pat. No. 6,082,724, which is hereby incorporated by reference, or a newspaper inserter.

In the preceding specification, the invention has been described with reference to specific exemplary embodiments and examples thereof. It will, however, be evident that various modifications and changes may be made thereto without departing from the broader spirit and scope of invention as set forth in the claims that follow. The specification and drawings are accordingly to be regarded in an illustrative manner rather than a restrictive sense.

What is claimed is:

1. A printing press comprising:
a printing unit printing images on a substrate;
a highlight application unit producing highlights on the substrate; and
a controller directing the highlight application unit to produce the highlight on the substrate.

2. The printing press as recited in claim 1 wherein the highlights produced on the substrate by the highlight application unit are transparent or semi-transparent.

3. The printing press as recited in claim 1 wherein the images printed on the substrate by the printing unit are text and graphics and the highlight application unit produces highlights over customer-specific text and graphics as directed by the controller.

4. The printing press as recited in claim 1 wherein the highlight application unit is an inkjet.

5. The printing press as recited in claim 1 wherein the substrate is processed into a group of printed products and the highlights on a first printed product of the group and a following second printed product of the group are the same.

6. The printing press as recited in claim 1 wherein the substrate is processed into a group of printed products and the highlights on a first printed product of the group and a following second printed product of the group are different.

7. The printing press as recited in claim 1 wherein the highlight application unit produces highlights of one or more shapes on the substrate and the one or more shapes each correspond to a specific highlight meaning.

8. The printing press as recited in claim 1 wherein the highlight application unit produces highlights of one or more colors on the substrate and the one or more colors each correspond to a specific highlight meaning.

9. The printing press as recited in claim 1 wherein the highlight application unit is located directly downstream of the printing unit.

10. The printing press as recited in claim 1 wherein the highlight application unit is a piece of post-press equipment.

11. The printing press as recited in claim 1 wherein the substrate is a web.

12. A method for producing a highlighted printed product comprising:
determining at least one of customer interests or customer information;
using the at least one of customer interests or customer information to identify customer-specific text and images from common text and graphics to be printed on a substrate;
printing the common text and graphics on the substrate;
highlighting the customer-specific text and graphics with a highlight application unit as the customer-specific text and graphics pass by the highlight application unit.

13. The method for producing a highlighted printed product as recited in claim 12 further comprising determining a timing of the of one or more printing units printing the common text and graphics on a web.

14. The method for producing a highlighted printed product as recited in claim 13 further comprising determining a time the customer-specific text and images will pass by a highlight application unit and directing the highlight application unit to highlight the customer-specific text and images at the time.

15. The method for producing a highlighted printed product recited in claim 12 wherein the at least one of customer interests or customer information is stored in a highlighting database.

16. The method for producing a highlighted printed product recited in claim 12 wherein the common text and graphics are stored in a highlighting database.

17. The method for producing a highlighted printed product recited in claim 12 wherein the customer-specific text and graphics are identified by a comparator.

18. The method for producing a highlighted printed product recited in claim 12 wherein the customer-specific text and graphics include advertisements.
